(19) United States
(12) Patent Application Publication
(10) Pub. No.: US 2004/0161364 A1
(43) Pub. Date: Aug. 19, 2004

(54) Carbon sequestration in aqueous environments

(76) Inventor: Peter S. Carlson, Chevy Chase, MD (US)

Correspondence Address: FOLEY AND LARDNER, SUITE 500, 3000 K STREET NW, WASHINGTON, DC, 20007, US

(21) Appl. No.: 10/773,246

(22) Filed: Feb. 9, 2004

Related U.S. Application Data
(60) Provisional application No. 60/446,109, filed on Feb. 10, 2003.
(60) Provisional application No. 60/509,254, filed on Oct. 8, 2003.

(51) Int. Cl. A01G 31/00

(52) U.S. Cl. 422/41; 47/1.4

(57) ABSTRACT

The present invention relates to the use of a substance, such as an aquatic herbicide, to facilitate the sequestration carbon dioxide by removing a portion of a plant biomass from a body of water.

This non-provisional application claims priority to U.S. provisional application serial Nos. 60/446,109, filed Feb. 10, 2003, and 60/509,254, filed Oct. 8, 2003, each of which is incorporated herein by reference in their entirety.

### BACKGROUND OF THE INVENTION

The present invention relates to the use of a compound, such as an aquatic herbicide, to facilitate the sequestration carbon dioxide in marine environments. Carbon sequestration is the capture and storage of carbon that would otherwise remain in, or be emitted into the atmosphere. Carbon dioxide is added to the atmosphere, for example, by burning fossil fuels and by recycling vegetation. Carbon dioxide is removed from the atmosphere by “natural sinks” like photosynthetic flora. An imbalance in the net flow of carbon dioxide into and from the atmosphere can cause fluctuations in atmospheric carbon dioxide levels.

While the specific effects of increased carbon dioxide concentrations on global climate conditions are continually being established, there is a consensus that a doubling of atmospheric carbon dioxide levels would have a variety of serious consequences on the environment. In their December 1999 report, “Carbon Sequestration Research and Development,” for example, the U.S. Department of Energy recalled recent predictions that global emissions of carbon dioxide, including those produced by human activities, will increase from 7.4 billion tonnes of atmospheric carbon (GtC) per year in 1997 to approximately 26 GtC/year by 2100. Such an increase would have a drammatic impact on temperature, weather patterns, and plant growth.

Accordingly, methods for decreasing the rate of carbon dioxide emissions while increasing the storage of carbon dioxide gas are highly desirable. Of all of such carbon management strategies, carbon sequestration is the most recent to tackle this problem.

Capturing carbon dioxide before it reaches the atmosphere is one of the cornerstones of the carbon sequestration management strategy. Such methods include the use of various biological and chemical processes to convert captured carbon dioxide into stable products. For instance, terrestrial ecosystems can be manipulated to enhance the capture and sequestration of carbon dioxide. However, carbon dioxide can also be concentrated into liquids or gas streams and transported to, or injected into the ocean or into deep underground geological formations such as oil and gas reservoirs, deep saline reservoirs, and deep coal streams and beds. In this respect, the ocean represents a vast natural “sink” that can both absorb and emit vast quantities of carbon dioxide from, and into, the atmosphere.

a. The ocean as a natural carbon sink

The ocean's living biomass represents only a fraction of the terrestrial ecosystem, but it converts almost as much inorganic carbon to organic matter, approximately 50 GtC/year, as do processes on land. The Intergovernmental Panel on Climate Change calculated in 1996 that the ocean contains 40,000 billion tonnes of carbon. The net oceanic uptake of carbon, as calculated from data from the mid-80s, is about 2-3 GtC/year. Accordingly, oceanic sequestration strategies strive to speed up absorbance of carbon dioxide by the ocean. Two main methods currently exist to expedite such a need:

(i) directly injecting carbon dioxide into the ocean; and

(ii) enhancing the net oceanic uptake of carbon dioxide by fertilizing oceanic flora.

i. Direct injection

A limitation of direct injection of carbon dioxide into the ocean is access to deep-sea sites, i.e., depths of greater than 1000 m, that are necessary for facilitating the storage of liquified carbon dioxide. Furthermore, the DOE stress that there is not enough knowledge to optimize costs, determine the effectiveness of such an approach, or to predict possible changes to the oceanic environment. For instance, little is known about optimizing injection strategies, or how to develop technology to monitor the injection site and surrounding area. One also must also take into account ocean currents, and most likely test injection strategies on oceanic models, prior to actual application. Furthermore, there are concerns about the effect of carbon dioxide on the acidity of oceanic water.

ii. Fertilization of oceanic flora

Another strategy for sequestering carbon dioxide is to enhance the growth rate of oceanic plant life, such as phytoplankton and algae, so that more carbon dioxide absorbed from the atmosphere by virtue of there being an increased amount of plant biomass. Thus, applying nutrients and fertilizers to the ocean is one method for promoting plant growth at sea.

In this respect, iron fertilization of the ocean has recently been reported. See, for instance, U.S. Pat. No. 6,440,367. However, the use of fertilizers in the ocean has been controversial. Some argue that ocean fertilization could directly affect the atmosphere-ocean system, resulting in changes to ocean circulation, modified surface water temperatures and brine content.

Accordingly, the present invention provides an alternative method for sequestering carbon dioxide in the ocean that is efficient and effective.

### SUMMARY

The present invention provides a method for sequestering carbon, comprising removing a portion of an aquatic plant biomass from a body of water, wherein the removed portion of the aquatic plant biomass sequesters carbon. In one embodiment, the step of removing the plant biomass portion from the body of water comprises applying a chemical to the plant biomass portion, wherein the chemical destroys, kills, or sinks the treated plant portion.

In another embodiment, the chemical is a plant growth regulator. In a preferred embodiment, the chemical is an aquatic herbicide. In yet another embodiment, the aquatic herbicide is selected from the group consisting of glyphosate, fluridone, 2,4-D, endothall, and diquat.

In a preferred embodiment the chemical is an algaecide.

In a further embodiment, the chemical is a liquid or a powder or a solid. In another embodiment, the chemical is sprayed onto the portion of the plant biomass. In another embodiment, the chemical is in a pellet.

In yet another embodiment, the body of water is the ocean.

In another embodiment, the plant biomass comprises at least one of algae, phytoplankton, or photosynthetic bacteria.

In a further embodiment, the plant biomass grows within a 10 meter layer from surface of the ocean. In another embodiment, the plant mass grows within a 50 meter layer from surface of the ocean.

The method also may comprise enhancing the growth of the plant biomass before or after removing the portion of the plant biomass. In one embodiment, the step of enhancing plant mass growth comprises adding a fertilizer to said plant mass. In a preferred embodiment, the fertilizer comprises at least one of iron, nitrogen, or phosphorous.

In another aspect of the present invention a method for storing carbon is provided, which comprises (i) traveling to a part of the ocean; and (ii) applying an aquatic herbicide to a portion of a plant biomass in the ocean, wherein the portion of the plant mass that is treated with the aquatic herbicide becomes removed from the total plant mass, and wherein the removed, treated plant portion is a store of carbon.

In one embodiment, the method further comprises applying a fertilizer to the plant mass to promote plant growth. In a preferred embodiment, the fertilizer comprises at least one of iron, nitrogen, or phosphorous.

In another aspect, a method for storing carbon is provided, comprising (i) traveling to a part of a body of water; (ii) applying a compound that promotes plant growth to a portion of a plant mass growing in the water; (iii) allowing the plant mass to grow; (iv) applying an aquatic herbicide to a portion of the plant mass, wherein the portion of the plant mass that is treated with the aquatic herbicide becomes removed from the total plant mass, and wherein the removed, treated plant portion is a store of carbon.

In yet another aspect of the present invention, a method for storing carbon is provided, which comprises (i) flying over a part of a body of water; and (ii) applying an aquatic herbicide to a portion of a plant mass growing in the water, wherein the portion of the plant mass that is treated with the aquatic herbicide becomes removed from the total plant mass, and wherein the removed, treated plant portion is a store of carbon.

Another method for storing carbon is provided, which comprises (i) flying over a part of a body of water; (ii) applying a compound that promotes plant growth to a portion of a plant mass growing in the water; (iii) allowing the plant mass to grow; (iv) applying an aquatic herbicide to a portion of the plant mass, wherein the portion of the plant mass that is treated with the aquatic herbicide becomes removed from the total plant mass, and wherein the removed, treated plant portion is a store of carbon.

Yet a further method for storing carbon is provided, which comprises (i) traveling to a part of a body of water; (ii) applying a compound that promotes plant growth to a portion of a plant mass growing in the water; and (iii) applying an aquatic herbicide to a portion of the plant mass, wherein the portion of the plant mass that is treated with the aquatic herbicide becomes removed from the total plant mass, and wherein the removed, treated plant portion is a store of carbon.

In one more aspect, a method for storing carbon is provided, which comprises (i) flying over a part of a body of water; (ii) applying a compound that promotes plant growth to a portion of a plant mass growing in the water; and (iii) applying an aquatic herbicide to a portion of the plant mass, wherein the portion of the plant mass that is treated with the aquatic herbicide becomes removed from the total plant mass, and wherein the removed, treated plant portion is a store of carbon.

In any of the methods described herein, a body of water may be the ocean or may be located in an artificial tank, pool, pond, lake, reservoir, or landlocked area of water.

The present invention also provides methods for applying for a carbon sequestration credit. Such a method comprises applying an aquatic herbicide to an area of plant life in a body of water, wherein some, but not all, of the plant life exposed to the aquatic herbicide is killed, and either calculating or measuring the amount of carbon dioxide sequestered.

Another method for applying for a carbon sequestration credit according to the present invention, comprises (i) growing a plant biomass on or below the surface of a body water; (ii) exposing a portion of the plant biomass to a substance that kills, destroys, or sinks plant life; (iii) collecting evidence of the amount of carbon dioxide sequestered in the killed, destroyed, or sunk plant life as a result of exposing a portion of the biomass to the substance; and (iv) applying for an appropriate credit from a credit-awarding body by providing the evidence needed to secure the credit.

In yet another aspect, a method for sequestering carbon, is provided that comprises (i) growing a plant biomass on or below the surface of a body water; (ii) applying a substance that kills, destroys, or sinks plant life to a portion of the plant biomass; and (iii) after a period of time repeating steps (i) and (ii). In one embodiment, the body of water is in a artificial tank, pool, pond, lake, reservoir, or landlocked area of water. In another embodiment, the body of water is in a artificial tank or artificial reservoir specifically assigned for sequestering carbon. In a preferred embodiment, the body of water is located near an industrial carbon dioxide-producing outlet. In another embodiment, the plant biomass comprises at least one of algae, phytoplankton, or photosynthetic bacteria. In a preferred embodiment, the substance is an aquatic herbicide.

In one embodiment, the aquatic herbicide is selected from the group consisting of glyphosate, fluridone, 2,4-D, endothall, and diquat. In another embodiment, the substance is an algaecide. In one other embodiment, the period of time is one month, two months, three months, four months, five months, six months, seven months, eight months, nine months, ten months, eleven months, a year, two years, three years, or more than three years.

### DETAILED DESCRIPTION

The present invention provides methods for sequestering carbon by removing, from a body of water, a portion of a living plant biomass. The carbon stored within the removed plant biomass is thereby sequestered. Additionally, the plant biomass that remains in the body of water can grow, or be encouraged to grow, into the resultant open space, thereby replenishing the removed plant life, which may then proceed to capture and store more carbon from the atmosphere. Thus, the present invention can provide multiple ways by which carbon can be effectively sequestered; namely, by directly removing plant life which contains carbon, and promoting plant growth which necessarily extracts carbon from the atmosphere.

Accordingly, one of the methods encompassed by the present invention entails applying, for example, a chemical to a portion of a plant biomass living in an area of a body of water, such as the ocean, so that (a) the treated portion of the plant biomass is removed from the area in which it was growing; (b) carbon is stored in the removed, treated plant portion; and (c) the plant biomass remaining around the treated area regrows and absorbs more carbon dioxide from the atmosphere. “Removed” in this context means, for example, that the treated portion of the plant biomass is killed, destroyed, disintegrated, sunk, or physically displaced from the aquatic or marine environment in which it naturally occurs. That is, a plant biomass may be treated in its natural environment with a substance that promotes death of the plant, or plant material can be scooped away, or otherwise collected, and displaced to another location in the body of water, or killed.

Typically, the earliest stages of ecological succession caused by such treatment exhibits the highest net productivity, in terms of carbon assimilation. A long-standing tenet of such ecology is that following a disturbance, an ecosystem immediately begins a process of recovery from that disturbance. Recovery takes place through the relatively orderly process of succession. In the broadest sense, ecological succession is the process of ecosystem development, whereby distinct changes in community structure and function occur over time. “Primary succession” is essentially ecosystem development on sites, such as bare rock, glaciated surfaces, or recently formed volcanic islands, which were previously unoccupied by living organisms. “Secondary succession” is ecosystem development on sites that were previously occupied by living organisms.

Depending on the intensity, frequency, scale, and duration of the disturbance, the impact on the structure and function of the ecosystem will vary, as will the time required for recovery from the disturbance. Any of alteration in the disturbance/recovery balance can cause changes in the ecosystem, such as increases or decreases in organism and plant population levels, as well as corresponding changes in the carbon-containing biomass associated with those organism and plant populations.

Recovery occurs through the combined action of several ecosystem dynamics: (1) the biotic community as a whole that modifies the physical environment through the many forms; (2) competition and coexistence between individual organisms and populations that cause changes in the diversity and abundance of species; and (3) energy flow shifts from net biomass production to respiration as more and more energy in the system is needed to support the growing and accumulating amount of standing biomass.

The interaction of these processes directs a recovering ecosystem through a number of stages of development that eventually lead to a structure and level of ecosystem complexity similar to what existed before the disturbance occurred.

Most of the components characteristic of ecological diversity increase during succession, especially in the early stages, often reaching their highest levels prior to full recovery of the climax state. Of particular importance in managed ecosystems is the fact that gross photosynthesis during the early stages of succession normally greatly exceeds total respiration, resulting in high net primary productivity and high harvest, i.e., carbon sequestration, potential.

Thus, one method requires “disturbing,” e.g. killing, removing, or altering the growth of an area of plant biomass living in a body of water using an aquatic herbicide or algaecide. The treated plant biomass may sink deep into the body of water, or be otherwise removed, thereby making the carbon stored within it unavailable to the atmosphere and, consequently, sequestered. The remaining plant life then can grow into the area treated with the herbicide or algaecide, i.e., the plant life undergoes “recovery” and “succession,” thereby replenishing the area with new plant growth, and absorbing additional carbon dioxide from the atmosphere.

Accordingly, as described herein, the net productivity of plant biomass in an aquatic or marine environment is increased because after treatment with a chemical, such as an herbicide, the slowly growing vegetation is replaced with rapidly growing vegetation. Furthermore, the presently-disclosed methods store the “removed” or dead plant biomass that has been treated with a chemical elsewhere in the aquatic or marine environment, such as in or on the ocean bed. Accordingly, an end result is the storage of more carbon in aquatic and marine vegetation and less in the atmosphere.

In a typical mature ecosystem, there are developmentally-staggered sites, i.e., “patches,” of growth that exist at various stages of succession. Such an ecosystem is relatively stable and resilient. See, for instance, Odum, The Strategy of Ecosystem Development, Science, vol.164, pp. 262-270, 1969. In such ecosystems, the frequency, intensity, and scale of disturbance is such that the system never reaches full maturity, but is nevertheless able to maintain the species diversity, stability, and energy-use efficiency characteristics of a mature ecosystem. In natural ecosystems where environmental disturbances are neither too frequent nor too seldom, both diversity of growth and productivity can, therefore, be high.

Accordingly, successional “patchiness” is an important factor in manipulating the dynamics of an ecosystem. Patch size, variation in patch development, and the nature of the interfaces between patches are important variables. The inherent patchiness of many agricultural, aquatic, and marine environments points out the potential application of intermediate disturbance and patchiness to aquatic and marine ecosystems management.

One aim of the methods described herein, therefore, is to accomplish such “patchiness” in a plant biomass living and growing in a body of water, such that the aquatic- or marine-based plant biomass exists in an ecosystem that has areas of high growth and productivity. The patches of empty plant biomass on a body of water represent treated portions of the plant biomass that have been removed or killed due to the treatment. Accordingly, the inventive method removes a portion of a plant biomass from its natural environment. The “natural environment” of a plant it is understood to be the area, location, or site that the plant grows and lives, or the environment in which a plant is seeded or made to grow. To that end, aquatic herbicides and algaecides are examples of certain types of chemicals that are specifically formulated for use in water to kill or control the growth of aquatic plants and vegetation.

“Broad spectrum herbicides,” for example, are capable of killing entire plant life. “Selective herbicides” will affect only some plants, such as dicotyledenous plants, like Eurasian watermilfoil (Myriophyllum spicatum). “Contact herbicides” cause parts of the treated plant to die back, leaving the roots alive and able to regrow. “Non-selective, broad spectrum” herbicides will generally affect all plants that they come in contact with. Any of such types of chemicals can be used according to the present invention.

In the U.S., aquatic herbicides are approved for aquatic use by the United States Environmental Protection Agency (EPA). Typically, aquatic herbicides can be sprayed directly onto aquatic plants or can be applied to water in either a liquid or pellet form. However, some individual states impose additional constraints on their use. For instance, many states require the applicator of an aquatic herbicide to be licensed, typically with the state agricultural department. Applicators also must hold permits to apply an aquatic herbicide to waters of a state. Furthermore, notification and postings of intended and applied use of an aquatic herbicide are required, as well as consideration for protection of rare plants or threatened and endangered species.

Permitted aquatic herbicides in the U.S. include, but are not limited to:

Glyphosate—(Rodeo®, AquaMaster®, and AquaPro®). This systemic broad spectrum herbicide is used to control floating-leaved plants like water lilies and shoreline plants like purple loosestrife. It is generally applied as a liquid to the leaves. Glyphosate does not work on underwater plants such as Eurasian watermilfoil. Although glyphosate is a broad spectrum, non-selective herbicide, a good applicator can somewhat selectively remove targeted plants by focusing the spray only on the plants to be removed. Plants can take several weeks to die and a repeat application is sometimes necessary to remove plants that were missed during the first application.

Fluridone—(Sonar® and Avast®). Fluridone is a slow-acting systemic herbicide used to control Eurasian watermilfoil and other underwater plants. It may be applied as a pellet or as a liquid. Fluridone can show good control of submersed plants where there is little water movement and an extended time for the treatment. Its use is most applicable to whole-lake or isolated bay treatments where dilution can be minimized. It is not effective for spot treatments of areas less than five acres. It is slow-acting and may take six to twelve weeks before the dying plants fall to the sediment and decompose. Although fluridone is considered to be a broad spectrum herbicide, when used at very low concentrations, it can be used to selectively remove Eurasian watermilfoil. Some native aquatic plants, especially pondweeds, are minimally affected by low concentrations of fluridone.

2,4-D—There are two formulations of 2,4-D approved for aquatic use. The granular formulation contains the low-volatile butoxy-ethyl-ester formulation of 2,4-D (AquaKleen® and Navigate®). The liquid formulation contains the dimethylamine salt of 2,4-D (DMA*41VM). 2,4-D is a relatively fast-acting, systemic, selective herbicide used for the control of Eurasian watermilfoil and other broad-leaved species. Both the granular and liquid formulations can be effective for spot treatment of Eurasian watermilfoil. 2,4-D has been shown to be selective to Eurasian watermilfoil when used at the labeled rate, leaving native aquatic species relatively unaffected.

Endothall—Dipotassium Salt—(Aquathol®) Endothall is a fast-acting non-selective contact herbicide which destroys the vegetative part of the plant but generally does not kill the roots. Endothall may be applied in a granular or liquid form. Typically endothall compounds are used primarily for short term, i.e., one season, control of a variety of aquatic plants. However, there has been some recent research that indicates that when used in low concentrations, endothall can be used to selectively remove exotic weeds; leaving some native species unaffected. Endothall can be used to treat smaller areas effectively, but is not effective in controlling Canadian waterweed (Elodea canadensis) or Brazilian elodea.

Diquat—(Reward®). Diquat is a fast-acting non-selective contact herbicide which destroys the vegetative part of the plant but does not kill the roots. It can be applied as a liquid and is used primarily for short term, i.e., one season, control of a variety of submersed aquatic plants. It is very fast-acting and is suitable for spot treatment. However, turbid water or dense algal blooms can interfere with its effectiveness.

Aquatic herbicides represent only one type of chemical that can be used as described herein. Algaecides, for example, also can be used. For instance, the amine salt of endothall (Hydrothol 191®) is a rapidly acting non-selective contact herbicide or algaecide. Copper compounds are also used to control algae. Such compounds can uncouple, inhibit, or disrupt photosynthesis and electron transportation. Compounds that bind to tubulin and disrupt or inhibit cell growth also may be applied. Similarly, compounds that inhibit mitochondria or amino acid synthesis can be used to create a removed “patch” of plant biomass from a body of water according to the present invention. Chemicals or compounds that attack the flotation structures, such as air bladders, of aquatic plants also may be targeted according to the present invention. Thus, one may deliberately “sink” a portion of a plant biomass growing in a body of water by applying a compound that destroys or affects the proper function or mechanism of the flotation system(s) in that plant.

Indeed, plant growth regulators can also be employed in practicing the present invention and include, but are not limited to (i) antiauxins, e.g., clofibric acid, 2,3,5-tri-iodobenzoic acid; (ii) auxins, e.g., 4-CPA, 2,4-D, 2,4-DB, 2,4-DEP, dichlorprop, fenoprop, IAA, IBA, naphthaleneacetamide, α-naphthaleneacetic acid, 1-naphthol, naphthoxyacetic acid, potassium naphthenate, sodium naphthenate, 2,4,5-T; (iii) cytokinins, e.g., 2iP, benzyladenine, kinetin, zeatin, (iv) defoliants, e.g., calcium cyanamide, dimethipin, endothal, ethephon, metoxuron, pentachlorophenol, thidiazuron, tribufos; (v) ethylene releasers, e.g., ACC, aviglycine, etacelasil, ethephon, glyoxime; and (vi) gibberellins, e.g., gibberellins, gibberellic acid.

Other plant growth regulators include, but are not limited to benzofluor, buminafos, carvone, ciobutide, clofencet, cloxyfonac, cyclanilide, cycloheximide, epocholeone, ethychlozate, ethylene, fenridazon, heptopargil, holosulf, inabenfide, karetazan, lead arsenate, methasulfocarb, prohexadione, pydanon, sintofen, triapenthenol, and trinexapac.

Compounds that are plant growth inhibitors include, but are not limited to abscisic acid, ancymidol, butralin, carbaryl, chlorphonium, chlorpropham, dikegulac, flumetralin, fluoridamid, fosamine, glyphosine, isopyrimol, jasmonic acid, maleic hydrazide, mepiquat, piproctanyl, prohydrojasmon, propham, 2,3,5-tri-iodobenzoic acid, morphactins, chlorfluren, chlorflurenol, dichlorflurenol, and flurenol. Also, growth retardants include, but are not limited to chlormequat, daminozide, flurprimidol, mefluidide, paclobutrazol, tetcyclacis, and uniconazole.

Any of these chemicals and formulations may be used to treat any photosynthetic plant or floral biomass, i.e., a “photosynthetic organism,” according to the present invention. For example, phytoplankton and algae typically populate areas of the open ocean and can be treated according to the methods described herein. Algae are classified into phyla based on their dominant photosynthetic pigments and include green algae (Chlorophyta), brown algae (Phaeophyta), and red algae (Rhodophyta). These three phyla are macroscopic and easily visible with the naked eye. For green algae, colors range from pale green to bright green, as well as yellowish to brownish green and originates from chlorophylls a and b. They grow in a variety of shapes and calcareous forms of green algae (especially Halimeda spp.) contribute significant amounts of calcium carbonate to marine sediments found in seagrass beds, and on coral reefs and beaches. Brown algae have colors ranging from brown to yellow-green brown resulting from the brown pigment fucoxanthin. Red algae are the most diversified of the algae with colors ranging from pale pink to dark burgundy red that are derived primarily from the red-pink pigment phycoerythrin. Calcareous red algae play an important role in the reef building process by adding calcium carbonate to the reef and aiding in cementation.

Phytoplankton can be either diatoms or dinoflagellates, and those that are large, i.e., several microns are typically eukaryotes. Microphytoplankton, for instance, are of the blue/green sort and are typically 200-20 microns in size. There also exist nano-phytoplantkon at 20 to 2 microns in size, and pico-phytoplankton, or protochlorphytes, that are from about 2 to 0.2 microns large. Diatoms account for a large fraction of the marine primary production, are non-motile and characterized by the yellow-brown pigment fucoxanthin and the presence of a silicious frustrule (skeleton). Some species contain toxins which can accumulate in shellfish, and can also cause massive fish kills. Dinoflagellates can be armored (cellulose plates) or naked, have two flagella and swim in a spiral trajectory. Dinoflagellates account for most of the bioluminescence observed in surface waters.

Accordingly, any photosynthetic organism or marine plant biomass can be targeted for treatment according to the present invention and include, but are not limited to Agarweed (i.e., Bangiophyceae, Florideophyceae, Gigartinales, Rhodymeniales, Ceramiales), Brown algae (i.e., Cystoseira, Sargassum, Pelvetia, Postelsia, Egregia, Macrocystis), Brown filament algae, Bull kelp (i.e., Nereocystis luetkeana), Cord grass (i.e., Spartina altemiflora), Crustose coralline algae, Eel grass, Elkhorn kelp, Featherboa kelp, Fucus rockweed, Green algae (i.e., “Chlorophyta” such as Enteromorpha, Ulva, Bryopsis, Codium, and Cladophora), Laminaria, Pickle weed, Red algae (i.e., Porphyra, Gelidium, Corallinales (articulated ornon-geniculate), Mastocarpus, Mazzaella, Prionitis, Chondracanthus, Gracilariopsis, Fauchea, Botryocladia, Plocamium, Microcladia, Polysiphonia, Delesseria, Botryoglossum), Rockweed, Salt grass (i.e., Distichlis), Salt wort, Sargasso weed, Sea bubble, Sea felt, Sea lettuce, Southern sea palm, Spongeweed, Surf grass (i.e., Phyllospadix), and Tar spot algae.

Other plant forms that exist in freshwater environments also can be treated according to the methods of the present invention. For instance, while the present invention contemplates the treatment of marine flora growing in a part of the ocean, it also contemplates the treatment of plant biomass growing in other bodies of water like reservoirs, lakes, ponds, and artificial tanks, for the purposes of sequestering carbon dioxide. Indeed, the present invention further encompasses the deliberate creation of bodies of water, in which are seeded any one of a number of flora, and their subsequent treatment with, for example, an aquatic herbicide, for the specific purposes of carbon sequestration. Thus, freshwater plants can be treated according to the presently-disclosed methods.

Thus, the present invention encompasses the removal and, optionally, the natural- or induced-regrowth of plant life, in any body of water. For instance, examples of a body of water, according to the present invention, include, but are not limited to naturally-occurring or man-made rivers, ponds, lakes, reservoirs, canals, bays, wetlands, coastal waters, navigable waters, territorial waters, territorial seas, non-tidal waters, and tidal waters of any country, not only those in and around the continental United States. The territorial seas of the United States is measured from the baseline in a seaward direction of a distance of three nautical miles.

One method of the present invention contemplates (i) traveling to a part of a body of water, either by boat, ship, or plane, (ii) identifying a portion or “patch” of a plant biomass to receive treatment, and (iii) applying any one of the compounds or class of compounds described herein to remove that portion or “patch” of the plant biomass. The compound may be in fluid or solid form and applied to the water by spraying, pouring, dissolving as pellet, or adding as a powder. The compound may be added at intervals to the same or different portions of the plant biomass. Those intervals may be every day, two days, three days, four days, five days, six days, one week, two weeks, four weeks, two months, three months, four months, five months, six months, seven months, eight months, nine months, ten months, eleven months, or a year or more or less frequently.

It will be evident to the skilled artisan how much of a chemical, compound, or formulation can be added to a particular area of a plant biomass growing in a body of water. For instance, one may apply a chemical at a concentration or molarity of about 10⁻³ M to about 10⁻¹¹ M, or from about 10⁻⁵ M to about 10⁻⁹ M, or apply a concentration of about 10⁻⁷ M of the chemical.

The size of the portion or “patch” of a plant biomass that is treated can vary. Thus, one may kill, sink, or otherwise remove, a part or fraction of the total, living or growing plant life.

The present invention also encompasses enhancing the rate of growth of a plant biomass or part thereof before or after treatment with the compound that kills or destroys a certain portion of the biomass. That is, the remaining, untreated plant biomass may be encouraged to grow into the vacated area. For example, an algal bloom growth may be induced by adding a plant growth regulator, and then a portion or patch destroyed by adding a herbicide, for instance, according to the present invention. Alternatively, the plant biomass can be encouraged to grow by feeding it nutrients and other growth enhancers in the area that had been treated with the compound, so as to encourage rapid growth and increased net intake of carbon dioxide by the emerging flora. The present invention encompasses both of such strategies.

According to the present invention, one may obtain, accrue, or claim “credits” for sequestering carbon dioxide from a credit-awarding body, such as a government, local municipal, business, industry, or agency, for example, as a reward for sequestering certain amounts of carbon dioxide. Accordingly, an entity may commission the treatment of a marine plant biomass by an applicator of an aquatic herbicide, for instance, in return for sequestration credits or monetary gain upon showing a desired, or required, level of sequestration. Alternatively, the applicator of any one of the treatments described herein may apply for sequestration credits.

Thus, it is possible for an entity to offset any emissions that it expels into the atmosphere, with credits earned by promoting the sequestration of carbon dioxide in flora according to the methods of the present invention.

The present invention encompasses man-made tanks or reservoirs that are designated for carbon sequestration, and seeded with plant life, which are then routinely killed and regrown with, for example, aquatic herbicides and plant growth regulators, so that carbon dioxide is constantly trapped within decaying plant life as well as within rapidly emerging new plant growth. Such tanks or reservoirs may be created or positioned next to carbon dioxide-producing sources, such as placed next to a power plant.

The present invention also contemplates the physical removal of a portion of a plant biomass in a body of water away from that biomass and to another open, unseeded, part of that body of water or to another body of water. Accordingly, the present invention encompasses the use of a net or other structure to scoop, capture, gather, or otherwise remove, a portion of a plant biomass, e.g., algae, from the site it exists, in order to create an empty “patch” into which the remaining plant life can regrow.

What is claimed is:

1. A method for sequestering carbon, comprising removing a portion of an aquatic plant biomass from a body of water, wherein the removed portion of the aquatic plant biomass sequesters carbon.

2. The method of claim 1, wherein the step of removing the plant biomass portion from the body of water comprises applying a chemical to the plant biomass portion, wherein the chemical destroys, kills, or sinks the treated plant portion.

3. The method of claim 2, wherein the chemical is a plant growth regulator.

4. The method of claim 2, wherein the chemical is an aquatic herbicide.

5. The method of claim 4, wherein the aquatic herbicide is selected from the group consisting of glyphosate, fluridone, 2,4-D, endothall, and diquat.

6. The method of claim 2, wherein the chemical is an algaecide.

7. The method of claim 1, wherein the plant biomass comprises at least one of algae, phytoplankton, or photosynthetic bacteria.

8. The method of claim 1, wherein the body of water is the ocean.

9. The method of claim 8, wherein the plant biomass grows within a 10 meter layer from surface of the ocean.

10. The method of claim 8, wherein the plant mass grows within a 50 meter layer from surface of the ocean.

11. The method of claim 2, wherein the chemical is a liquid.

12. The method of claim 2, wherein the chemical is a powder.

13. The method of claim 2, wherein the chemical is solid.

14. The method of claim 11, wherein the chemical is sprayed onto the portion of the plant biomass.

15. The method of claim 13, wherein the chemical is in a pellet.

16. The method of claim 1, further comprising enhancing the growth of the plant biomass before or after the step of removing the portion of the plant biomass.

17. The method of claim 16, wherein the step of enhancing plant mass growth comprises adding a fertilizer to said plant mass.

18. The method of claim 17, wherein the fertilizer comprises at least one of iron, nitrogen, or phosphorous.

19. A method for storing carbon, comprising (i) traveling to a part of a body of water; and (ii) applying an aquatic herbicide to a portion of a plant biomass in the water, wherein the portion of the plant mass that is treated with the aquatic herbicide becomes removed from the total plant mass, and wherein the removed, treated plant portion is a store of carbon.

20. The method of claim 19, further comprising applying a fertilizer to the plant mass to promote plant growth.

21. The method of claim 17, wherein the fertilizer comprises at least one of iron, nitrogen, or phosphorous.

22. A method for storing carbon, comprising (i) traveling to a part of a body of water; (ii) applying a compound that promotes plant growth to a portion of a plant mass growing in the water; (iii) allowing the plant mass to grow; (iv) applying an aquatic herbicide to a portion of the plant mass, wherein the portion of the plant mass that is treated with the aquatic herbicide becomes removed from the total plant mass, and wherein the removed, treated plant portion is a store of carbon.

23. A method for storing carbon, comprising (i) flying over a part of a body of water; and (ii) applying an aquatic herbicide to a portion of a plant mass growing in the water, wherein the portion of the plant mass that is treated with the aquatic herbicide becomes removed from the total plant mass, and wherein the removed, treated plant portion is a store of carbon.

24. A method for storing carbon, comprising (i) flying over a part of a body of water; (ii) applying a compound that promotes plant growth to a portion of a plant mass growing in the water; (iii) allowing the plant mass to grow; (iv) applying an aquatic herbicide to a portion of the plant mass, wherein the portion of the plant mass that is treated with the aquatic herbicide becomes removed from the total plant mass, and wherein the removed, treated plant portion is a store of carbon.

25. A method for storing carbon, comprising (i) traveling to a part of a body of water; (ii) applying a compound that promotes plant growth to a portion of a plant mass growing in the water; and (iii) applying an aquatic herbicide to a portion of the plant mass, wherein the portion of the plant mass that is treated with the aquatic herbicide becomes removed from the total plant mass, and wherein the removed, treated plant portion is a store of carbon.

26. A method for storing carbon, comprising (i) flying over a part of a body of water; (ii) applying a compound that promotes plant growth to a portion of a plant mass growing in the water; and (iii) applying an aquatic herbicide to a portion of the plant mass, wherein the portion of the plant mass that is treated with the aquatic herbicide becomes removed from the total plant mass, and wherein the removed, treated plant portion is a store of carbon.

27. A method for applying for a carbon sequestration credit, comprising applying an aquatic herbicide to an area of plant life in a body of water, wherein some, but not all, of the plant life exposed to the aquatic herbicide is killed, and either calculating or measuring the amount of carbon dioxide sequestered.

28. A method for sequestering carbon, comprising (i) growing a plant biomass on or below the surface of a body water; (ii) applying a substance that kills, destroys, or sinks plant life to a portion of the plant biomass; and (iii) after a period of time repeating steps (i) and (ii).

29. The method of claim 28, wherein the body of water is in a artificial tank, pool, pond, lake, reservoir, or landlocked area of water.

30. The method of claim 29, wherein the body of water is in a artificial tank or artificial reservoir designated for sequestering carbon.

31. The method of claim 28, wherein the body of water is located near an industrial carbon dioxide-producing outlet.

32. The method of claim 28, wherein the plant biomass comprises at least one of algae, phytoplankton, or photosynthetic bacteria.

33. The method of claim 28, wherein the substance is an aquatic herbicide.

34. The method of claim 33, wherein the aquatic herbicide is selected from the group consisting of glyphosate, fluridone, 2,4-D, endothall, and diquat.

35. The method of claim 28, wherein the substance is an algaecide.

36. The method of claim 28, wherein the period of time is one month, two months, three months, four months, five months, six months, seven months, eight months, nine months, ten months, eleven months, a year, two years, three years, or more than three years.

37. A method for applying for a carbon sequestration credit, comprising, comprising (i) growing a plant biomass on or below the surface of a body water; (ii) exposing a portion of the plant biomass to a substance that kills, destroys, or sinks plant life; (iii) collecting evidence of the amount of carbon dioxide sequestered in the killed, destroyed, or sunk plant life as a result of exposing a portion of the biomass to the substance; and (iv) applying for an appropriate credit from a credit-awarding body by providing evidence needed to secure the credit.

38. The method of claim 19, wherein the body of water is the ocean or is located in an artificial tank, pool, pond, lake, reservoir, or landlocked area of water.

39. The method of claim 22, wherein the body of water is the ocean or is located in an artificial tank, pool, pond, lake, reservoir, or landlocked area of water.

40. The method of claim 23, wherein the body of water is the ocean or is located in an artificial tank, pool, pond, lake, reservoir, or landlocked area of water.

41. The method of claim 24, wherein the body of water is the ocean or is located in an artificial tank, pool, pond, lake, reservoir, or landlocked area of water.

42. The method of claim 25, wherein the body of water is the ocean or is located in an artificial tank, pool, pond, lake, reservoir, or landlocked area of water.

43. The method of claim 26, wherein the body of water is the ocean or is located in an artificial tank, pool, pond, lake, reservoir, or landlocked area of water.
